(19) United States
(12) Patent Application Publication
(10) Pub. No.: US 2011/0232984 A1
(43) Pub. Date: Sep. 29, 2011

(54) Independent axle drive

(76) Inventor: Charles Richard Wurm, San Jose, CA (US)

(21) Appl. No.: 13/134,246

(22) Filed: Jun. 2, 2011

Related U.S. Application Data
(63) Continuation-in-part of application No. 12/658,687, filed on Feb. 13, 2010.

(51) Int. Cl. B60K 17/16; B60K 8/00

(52) U.S. Cl. 180/69.6

(57) ABSTRACT

The presented application is used to power an electric vehicle using this efficient and compact method of transmitting rotational power within a single compact enclosure. The unforeseen positive byproducts from this system of transmitting rotational energy are flywheel and gyroscopic energies.

### CROSS-REFERENCE TO RELATED APPLICATIONS

This application and all accompanying documents constitute a Continuation in Part of application Ser. No. 12/658,687 by the present inventor.

### FEDERALLY SPONSORED RESEARCH

Not Applicable

### SEQUENCE LISTING OR PROGRAM

Not Applicable

### BACKGROUND

1. Field

This application relates to an electric and flywheel drive system with gyroscopic stabilization in an electric vehicle.

2. Prior Art

Electric vehicle propulsion systems with flywheel energy storage are well known in prior art. Many differently integrated designs have been proposed. Several discuss isolating the flywheel gyroscopic affect from the vehicle.

One example of an electric vehicle using a flywheel is shown in U.S. Pat. No. 5,427,194 Miller (1995) Electrohydraulic Vehicle with Battery Flywheel. It uses a magnetically suspended flywheel to store mechanical energy. The majority of the flywheel weight is the galvanic cells or batteries driving the vehicle. An electric drive motor powers the flywheel. It is also connected to a hydraulic pump and a generator. Flywheel energy is used to supply peak electrical demand power. When stopped this energy is used to charge the batteries. The vehicle is powered by a hydraulic motor through a conventional automotive differential gear and axle assembly.

During vehicle slowdown and braking kinetic energy can be stored in the flywheel. It could also be used to charge the batteries. As needed a hydraulic accumulator can also store energy.

The volume of batteries needed to drive an electric vehicle will create a large flywheel. Balancing this flywheel containing gimbaled wet cell batteries would be difficult. The onboard balancing system shown is complex and battery maintenance would be problematic.

Another example of an electric vehicle using a flywheel for energy storage is U.S. Pat. No. 4,233,858 Rowlett (1980) Flywheel drive system having a split path electromechanical transmission using a flywheel as a power source. One path is a mechanical drive train connecting flywheel energy to vehicle drive wheels. The other path is an electromechanical drive train of which the mechanical portion is shared with the mechanical drive train by virtue of a common planetary gear arrangement for dividing or combining the power transmitted to or from the flywheel. A battery may be included in the system to make up certain losses from operation and to provide the initial start up power. A simplified control system is provided to regulate the transmission of power over the separate parallel paths. Energy is recaptured during braking. It can recharge the flywheel and, or, battery.

This is a complicated system. The flywheel power rating of less than 1 kilowatt hour is low. Most electric vehicles are in the 10 to 40 kilowatt hour range. A large battery pack is needed for a reasonable driving range. Drive power goes through a conventional automotive differential gear and axle assembly.

My final example of an electric vehicle using a flywheel is U.S. Pat. No. 4,629,947 Hammerslag et al (1986), Electric Vehicle Drive System. In this electric drive vehicle the flywheel supplies additional electric energy during peak loads. Like starting from a stop or at high speeds. It is also used to recoup energy during braking to extend vehicle range. It is a sophisticated flywheel system in a vacuum sealed housing. The flywheel assembly is gimbaled to minimizing gyroscopic effects to the vehicle chassis. This design may also have the flywheel as part of the generator.

This design states that all mechanical drive and resultant friction is eliminated. Because it has direct drive electric motors at each drive wheel. Direct drive 1:1 ratio wheel motors require a large amount of starting energy. They also provide high un-sprung weight for the suspension arms. Electric motors within or near wheel assemblies attract magnetic debris.

Additional Prior Art shows many designs proposing a combination of flywheel drive with electric and different propulsion systems. Such as U.S. Pat. No. 3,939,935 Gill (1976) Electric Power Means for Vehicles, U.S. Pat. No. 4,532,769 Vestermark (1985) Energy Storing Flywheel Assembly, U.S. Pat. No. 3,672,244 Nasvytis (1972) Flywheel Automotive Vehicle and many others.

All these designs and many others presented are complicated. They rely on computer interface of energy storage, control and distribution systems. All flywheel energy systems described are independent of the vehicle requiring integration.

3. Objects and Advantages

The objects and advantages of the present patent application are:
(a) a simplified system with motors and gearing in one compact assembly,
(b) a compact gear system that can directly replace inefficient conventional automotive differential gear and axle assemblies,
(c) a drive system allowing each wheel to be independently driven by a separate motor,
(d) a drive system mounted on the vehicle chassis not increasing the weight of any suspension member,
(e) a drive system in which the rotational energy produced by each motor drive gear is efficiently transmitted in the same plane of motion as the gear driving each axle,
(f) a drive assembly which because of its unique shape and mass can produce flywheel energy to extend the range of the vehicle,
(g) a drive assembly which because of its unique shape and mass can produce gyroscopic energy to help stabilize the vehicle.

### SUMMARY

The present invention is an efficient drive system assembly with two large parallel gears. The mass of these main drive components when rotating can store mechanical energy. This spinning shape also produces a gyroscopic effect that stabilizes the vehicle by resisting body roll. Both effects are byproducts of this efficient simple mechanical drive design.

### DRAWINGS

### Figures

Drawings are not to scale.

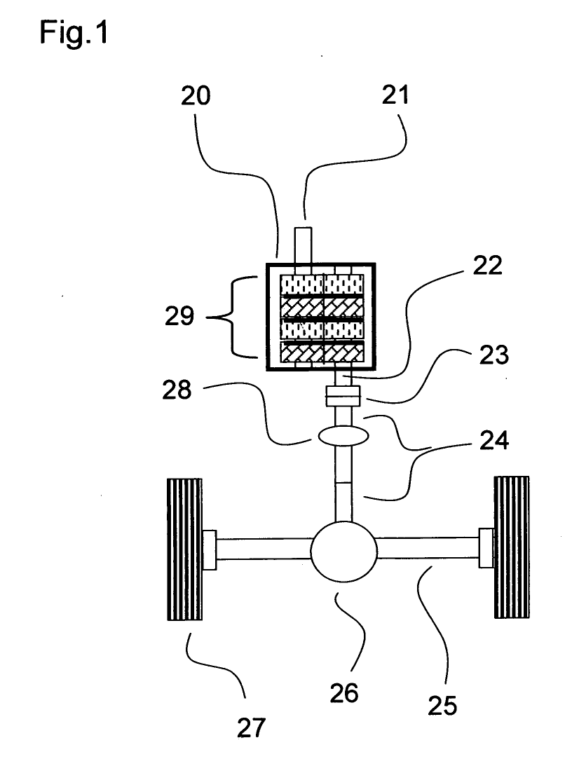

FIG. 1 a representation of a standard drive system showing an transparent view of a four gear ratio transmission, drive coupling, drive shaft, constant velocity joint, rear axle with the differential gear, and the vehicle drive wheels.

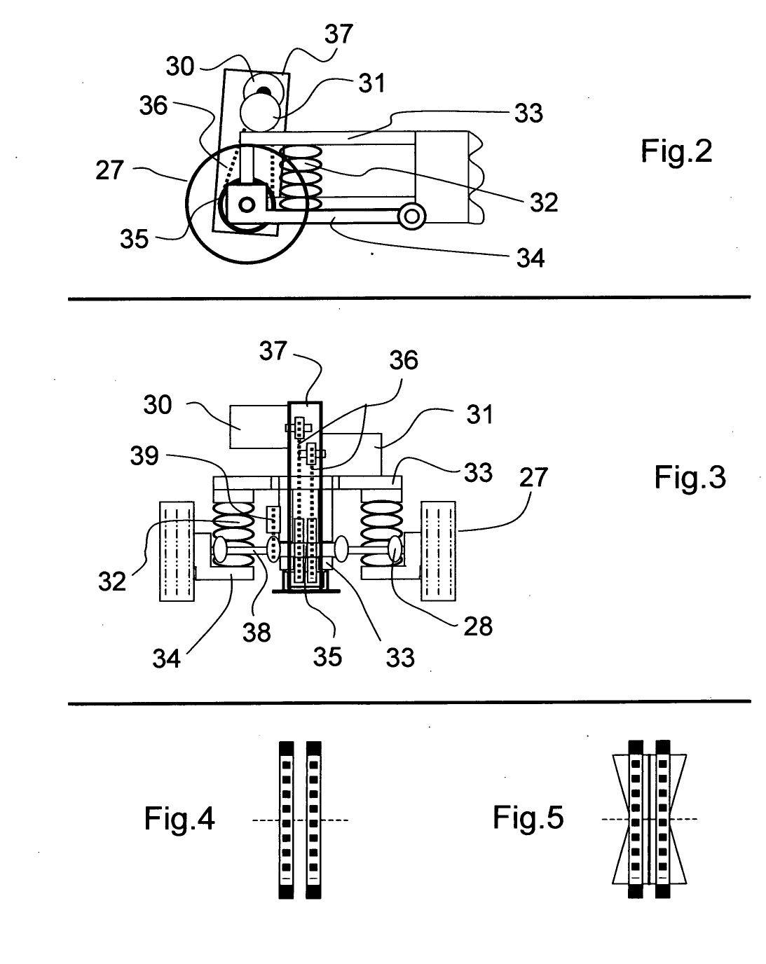

FIG. 2 side view of the Independent Axle Drive system showing rear portion of chassis, moving suspension member, suspension spring, two motors attached to a transparent view of the drive assembly housing, a drive chain or belt, and one vehicle drive wheel.

FIG. 3 rear view of the Independent Axle Drive system showing motors attached to a transparent view of the drive assembly housing, the rear portion of chassis, both moving suspension member, suspension springs, drive axles, constant velocity joints and vehicle drive wheels.

FIG. 4 a view of the two large round drive cluster assembly gears as seen in FIG. 3, shown by themselves without axles or any other drive components, a side view of these gears would show them as circles.

FIG. 5 a view of the two large round drive cluster assembly gears as seen in FIG. 3, shown by themselves without axles of any other drive components, the gears in this view have increased mass especially at their outside edge.

### REFERENCE NUMERALS

20 transmission housing
21 input shaft to transmission
22 output shaft from transmission
23 output shaft connecting flange
24 drive shaft
25 differential gear drive axle
26 differential gear housing
27 vehicle drive wheel
28 constant velocity joint
29 four ratios drive gear assembly
30 left motor from rear of vehicle
31 right motor from rear of vehicle
32 suspension spring
33 vehicle chassis
34 moving suspension member
35 drive cluster assembly
36 drive chain or belt
37 drive assembly housing
38 drive axle
39 vacuum pump

### DETAILED DESCRIPTION

### Preferred Embodiments

### Figures

FIG. 1 is a simplified view of a Typical Drive System showing a transparent view of the transmission housing (20), its input shaft (21), the output shaft (22), the output shaft connecting flange (23), the drive shaft (24), the constant velocity joint (28), the rear axle (25), the differential gear housing (26) and the drive wheels (27). The four drive gear ratios designated by bracket (29) are within the transmission housing (20).

FIG. 2 is a side view of the Independent Axle Drive assembly and the rear portion of a vehicle chassis. The vehicle drive wheel (27) is shown as a transparent image. You see end views of the opposing motors (30) and (31), which are attached to the drive assembly housing (37), the suspension spring (32) in shown sitting beneath a portion of the chassis (33), and on top of the moving suspension member (34), a small portion of the drive cluster assembly can be seen (35), a portion of the drive chain or belt (36) is also shown.

FIG. 3 is a rear view of the Independent Axle Drive assembly and a portion of the vehicle chassis. The opposing motors (30) and (31) are mounted to a transparent view of the drive assembly housing (37), the motors are connected to gears in the drive cluster assembly (35) with chains or belts (36), both moving suspension members (34) are below suspension springs (32), the chassis (33) is shown above the springs and also a lower portion of the chassis (33) can be seen connected to and supporting the drive assembly housing (37). Four constant velocity joints (28) are shown on two drive axles (38), the drive cluster assembly (35) is shown in the bottom of the drive assembly housing (37). The vacuum pump (39) is mounted on the left side of the drive assembly housing (37) just above where the axles (38) enter the drive assembly housing (37). The vacuum pump (39) is driven by the rotation of the constant velocity joint (28) directly below it.

FIG. 4 is an end view of the two standing parallel gears within the drive cluster assembly (35) as seen in FIG. 3. They are shown without axles or any other drive components from the drive cluster assembly (35).

FIG. 5 is an end view of the two standing parallel gears within the drive cluster assembly (35) as seen from FIG. 3. They are shown without axles or any other drive components from the drive cluster assembly (35). This view shows one example of how the mass of these gears might be increased.

### Preferred Embodiments

### Operation

### Definitions

A Constant Velocity Joint (28) is a mechanical fitting placed in a drive shaft or axle that allows the drive shaft or axle to bend at the Constant Velocity Joint to a non straight alignment while transmitting power. Earlier versions of this type of fitting on drive shafts were called Universal Joints.

Un-sprung Weight (concerning vehicles) describes the suspension members that move beneath the suspension springs. These moving suspension members (34) directly hold the vehicle drive wheels. In the drawings these are item 34. The top end of the spring rests against the vehicle chassis. The vehicle chassis is “sprung weight” supported by springs. The moving suspension members at the bottom of the spring are described as the “un-sprung weight”, below the spring. These suspension members move up and down with the wheels when encountering irregularities in the road surface.

### Kinetic Energy and Frictional Losses in the Typical Drive System:

To understand the non-obvious and unique characteristics of the Independent Axle Drive system the moving parts of a Typical Drive System must be reviewed. We will discuss the kinetic energy and frictional losses occurring within a Typical Drive System as compared to the Independent Axle Drive.

See FIG. 1. The operation of a Typical Drive System starts at the input shaft to the transmission (21). Here the drive energy enters the transmission housing (20) and rotates the four drive gear ratio assembly (29). All four sets of gears rotate simultaneously. The gear ratio selected to transmit drive power is interlocked internally within the gear shafts. Once a ratio selection is made all four gear sets continue to rotate. Only the selected set transmits power. The power leaves the transmission through the output shaft from transmission (22). At the output shaft connecting flange (23) it is connected to the drive shaft (24), The other end of the drive shaft is connected to the differential gear housing (26). The gears in the differential gear housing (26) convert drive shaft (24) rotational energy to differential gear drive axle (25) rotational orientation. The energy then powers each drive wheel (27).

### Kinetic Energy in a Typical Drive System:

Kinetic energy increases linearly with the mass of the rotating object and as a square with an increase in rotational speed of the object. For these reasons the small mass and diameters of the rotating drive parts in a Typical Drive System create a small amount of usable kinetic energy.

### Frictional Losses in Typical Drive System:

Gears transmitting mechanical power generate friction and heat where the faces of the gear mesh. This heat is lost energy. They must also move through a viscous lubricant. The Typical Drive System has meshed gear sets in the transmission and the differential assembly who's movement has friction, creating heat and wasting energy.

### Independent Axle Drive System: Kinetic Energy and Friction

See FIG. 2 and FIG. 3. Drive energy transmitted from motors (30) (31) goes directly to the gears of the drive cluster assembly (35) using drive chains or belts (36). This method moves a small amount of mass during the transit of drive power and creates less friction than the meshed drive gears used in the Typical Drive System. The larger diameter unmeshed drive gears within the drive cluster assembly (35) when spinning have more kinetic energy than components of the Typical Drive System.

When driving the vehicle and shutting off motor power it coasts very, very well. The improved kinetic energy storage ability of the drive cluster assembly (35) explains this unforeseen attribute and unexpected result.

### Kinetic Energy and Frictional Losses Summary:

From the previous descriptions the operation of the Typical Drive System creates:

1) Less kinetic energy than the Independent Drive System. Although is moves greater mass it creates a smaller amount of useful kinetic energy.
2) More friction and more energy loss through heat by the use of meshed gear sets whereas the Independent Axle Drive has no meshed gear sets.

### Increased Kinetic Energy:

See FIG. 4 and FIG. 5: Additional kinetic energy could be harnessed by modify the shape of the gears within the drive cluster assembly (35). FIG. 4 shows the standard shaped gears and FIG. 5 shows one method mass could be increased at the higher speed portion of the gear to increase kinetic energy and improve the flywheel effect of these rotating gears. The best performance might be expected by moving mass from the inner diameter portion of these gears to the outside portion of these gears where the speed is greatest. Thereby keeping the overall weight of the gear the same.

### Vacuum Enhancement of Kinetic Energy Storage:

See FIG. 3: As previously discussed when spinning the gears within the drive assembly housing (37) act as flywheels. To improve the storage of their kinetic energy they should be kept in a vacuum to reduce the energy lost by impacting air when in motion. The drive assembly housing (37) would be kept under vacuum. The vacuum pump (39) would be used to help maintain vacuum when the vehicle is in motion. This pump would be directly powered by the rotation of the constant velocity joint (28) and drive axle (38) directly below it as shown in FIG. 3.

### Independent Axle Drive System: Gyroscopic Energy:

The large diameter gears spinning within the drive cluster assembly (35) in addition to enhancing the creation of kinetic energy have a gyroscopic effect. The flywheel energy storage systems used in other vehicles are specifically not attached and free floating in relation to the vehicle chassis (33). Many have gimbals placement.

The drive cluster assembly (35) of Independent Axle Drive system acts as a large gyroscope directly attached to the vehicle chassis (33). When the vehicle body rolls during cornering the gyroscopic action of the spinning flywheels resists this movement and adds stability to the chassis (33). This improves the handing of the vehicle. During high speed cornering, with higher gyroscope speed, this is a particular asset. The car is encouraged to remain very flat through cornering.

### CONCLUSION, RAMIFICATIONS, AND SCOPE

Thus the reader will see that this drive system is a more efficient way to transmit vehicle drive energy by capturing and using a greater amount of the kinetic energy created as a byproduct of this new drive system.

It also makes use of gyroscopic energy to enhance vehicle stability.

My descriptions contain many specificities, these should not be construed as limitations on the scope, but rather as an exemplification of one [or several] preferred embodiments thereof. Many other variations are possible.

Accordingly, the scope should be determined not necessarily by the embodiment(s) illustrated, but by the amended claims and their legal equivalents.

1. Two independent gear and chain or belt drive systems operating directly adjacent to one another and constructed as a compact efficient drive system assembly, said drive assembly sits within a sealed case, said assembly case is a single independent module, said drive assembly within said assembly case, consists of two larger gears and fittings, forming a drive cluster assembly, that form the differential portion of said drive assembly powering the vehicle drive wheels, these large gears are able move independently from one another and are powered by a separate motor or other means, that provides power individually or, together, at the same or, different speeds, they may even move in different directions, said drive assembly case and said motors or other means used to power said assembly are mounted on a vehicle chassis and not mounted to the moving suspension members holding the vehicle drive wheels, and so do not increase the un-sprung weight of said moving suspension members,

2. a drive system as recited in claim 1 wherein said rotational movement of said drive cluster assembly because of the position, shape, weight and motion of the larger gears stores kinetic energy allowing the vehicle to more efficiently use propulsion energy,

3. a drive system as recited in claim 1 wherein said rotational movement of said drive cluster assembly because of the position, shape, weight and motion of the larger gears and how these gears are attached and orientated to the chassis, creates a gyroscopic energy effect adding stability to the vehicle,

4. a drive system as recited in claim 1 wherein the sealed case containing said drive assembly is kept under vacuum when the assembly is in operation to reduce the air resistance to the spinning parts and increase the efficient storage of kinetic energy.
